(19) United States
(12) Patent Application Publication
(10) Pub. No.: US 2011/0146215 A1
(43) Pub. Date: Jun. 23, 2011

(54) OIL SEPARATOR

(75) Inventors: Geonho Lee, Seongnam-si (KR); Inhwe Koo, Seongnam-si (KR); Young chang Han, Jeonju-si (KR)

(73) Assignees: DOOWON TECHNICAL COLLEGE, Anseing-shi (KR); DOOWON ELECTRONIC CO., LTD., Asan-shi (KR)

(21) Appl. No.: 13/002,071

(22) PCT Filed: Jun. 22, 2009
(86) PCT No.: PCT/KR09/03322

§ 371 Date: Feb. 3, 2011

(30) Foreign Application Priority Data
Jul. 2, 2008 (KR) 10-2008-0063900

(51) Int. Cl. B01D 45/08; B01D 45/16

(52) U.S. Cl. 55/456; 55/459.1; 55/461

(57) ABSTRACT

An oil separator comprises: a hollow outer body having an inlet and a drain hole; and an inner tube spaced apart from an inner peripheral surface of the outer body and having a discharge hole at a center thereof. The inner peripheral surface of the outer tube guides oil toward the drain hole opposite to the discharge hole. The present invention provides an oil separator that maximizes an oil separating effect through enhancement of a centrifugal force. The present invention also provides an oil separator that maximizes an oil separating performance by preventing gas and oil from being remixed by guiding the flow direction of the oil separated by a centrifugal force using a spiral portion and a taper.

### TECHNICAL FIELD

The present invention relates to an oil separator, and more particularly to an oil separator that used in a scroll compressor to maximize oil separating performance by separately discharging oil and gas in a natural manner using the principle of centrifugal separation.

### BACKGROUND ART

In general, a scroll compressor includes a fixed scroll having a spiral scroll wrap and fixed irrespective of rotation of a drive shaft and an orbiting scroll also having a spiral scroll wrap and configured to orbit as the driven shaft rotates. Such a scroll compressor is an apparatus adapted to compress a refrigerant through a pocket formed between the scroll wraps such that its volume varies as the orbiting scroll orbits with respect to the fixed scroll with the refrigerant being suctioned into a compression chamber formed between the fixed scroll and the orbiting scroll.

An example of a conventional scroll compressor is disclosed in Korean Patent Application No. 10-2006-0053798 which will be described with reference to FIG. 1A to 1C.

As illustrated in FIGS. 1A to 1C, the conventional scroll compressor includes a housing, a drive unit configured to generate a rotational force, a fixed scroll 500 having a scroll wrap 510 to compress suctioned fluid and fixed irrespective of rotation of a drive shaft 200, and a orbiting scroll 400 configured to orbit by a rotational force of the drive unit and having a spiral scroll wrap 410.

A discharge pipe (not shown) and a discharge chamber 610 are formed at a front portion of the housing and a passage through which a refrigerant passes is formed at an intermediate portion 300 of the housing. A suction pipe (not shown) and a suction chamber 710 are formed at a rear portion 700 of the housing.

The drive unit includes a drive motor 230 having a stator 210 and a rotor 220 located inside the stator 210, and a drive shaft 200 inserted into a central portion of the drive motor 230 to be rotated.

A main bearing 240 and a sub-bearing 250 are installed on the front side of the drive shaft 200 driven and rotated by the drive motor 230 such that the sub-bearing 250 supports a circumferential portion of an eccentrically operated portion 260 eccentrically installed with respect to the drive shaft 200.

A return passage 290 is formed through inside the drive shaft 200 along a lengthwise thereof such that oil returns from the discharge chamber 610 of the front portion 600 of the housing.

The eccentrically operated portion 260 of the drive shaft 200 is connected to the orbiting scroll 400 by the medium of the sub-bearing 250.

Accordingly, as the drive shaft 200 rotates, the eccentrically operated portion 260 eccentrically rotates with respect to the drive shaft 200 such that the orbiting scroll 400 installed in the eccentrically operated portion 260 by the medium of the sub-bearing 250 orbits with respect to the fixed scroll 500.

As described above, a pocket is formed between the scroll wraps 410 and 510 such that its volume continuously varies as the orbiting scroll 400 orbits to compress the refrigerant.

A discharge port 560 configured to send out the compressed refrigerant to the discharge chamber 610 at the front portion 600 of the housing is formed at a central portion of the fixed scroll 500.

Meanwhile, the discharge chamber 610 is formed inside the front portion 600 of the housing and a discharge pipe 650 communicated with the discharge chamber 610 is formed at one side of the outer peripheral surface thereof.

An oil separator 680 configured to separate the refrigerant introduced into the discharge chamber 610 into oil and gas is formed at the front portion 600 of the housing.

As illustrated in FIGS. 1B and 1C, the oil separator 680 has a generally cylindrical space in which a refrigerant introducing pipe 681 formed in the tangential direction thereof and a gas branch pipe 682 and an oil branch pipe 683 configured to branch the introduced refrigerant into gas and oil to discharge them are formed. Accordingly, the tangentially introduced refrigerant is separated into oil and gas by the principle of centrifugal separation while it is rotating in the oil separator 680 so that the oil and gas can be discharged in a natural manner.

In particular, a guide boss 684 is formed at a central bottom portion of the cylindrical space to enhance the effect of centrifugal separation. An opening contacts with the fixed scroll 500 to be closed. Thus, the gas is discharged through a passage formed between the gas branch pipe 682 and the fixed scroll 500.

However, in the conventional scroll compressor, since the cross-sectional area of the refrigerant passage in the oil separator 680 is made constant such that the magnitude of the centrifugal force becomes almost constant as the refrigerant proceeds, oil cannot be sufficiently separated when the suction speed of the refrigerant is relatively low.

In this case, as the oil is contained in the refrigerant gas when it is discharged, lubricating efficiency lowers, deteriorating the performance of the compressor.

Further, as the cross-sectional area of the refrigerant passage deviating from the guide boss 684 is large, fluid velocity cannot be sufficiently secured, lowering an oil separating effect due to a centrifugal force.

Besides, as the suctioned refrigerant continuously rotates along the circumference of the guide boss 684, the oil separated and left on the bottom is remixed with the suction refrigerant, deteriorating an oil separating effect.

### DISCLOSURE

### Technical Problem

Therefore, it is an object of the present invention to provide an oil separator that maximizes an oil separating effect through enhancement of a centrifugal force.

Another object of the present invention is to provide an oil separator that maximizes an oil separating performance by preventing gas and oil from being remixed by guiding the flow direction of the oil separated by a centrifugal force using a spiral portion and a taper.

### Technical Solution

In order to achieve the above-mentioned objects, there is provided an oil separator comprising: a hollow outer body having an inlet and a drain hole; and an inner tube spaced apart from an inner peripheral surface of the outer body and having a discharge hole at a center thereof, wherein the inner peripheral surface of the outer tube guides oil toward the drain hole opposite to the discharge hole.

Preferably, a taper is formed on the inner peripheral surface of the outer tube such that the inner diameter of the outer tube becomes larger as it goes toward the drain hole.

Preferably, a spiral portion is formed on the inner peripheral surface of the outer body.

Preferably, the inlet is formed in a tangential direction of the inner peripheral surface of the outer body.

Preferably, an oil groove is formed on the inner peripheral surface of the outer body along a lengthwise direction thereof.

### DESCRIPTION OF DRAWINGS

FIG. 1A is a longitudinal sectional view illustrating an example of a conventional scroll compressor;

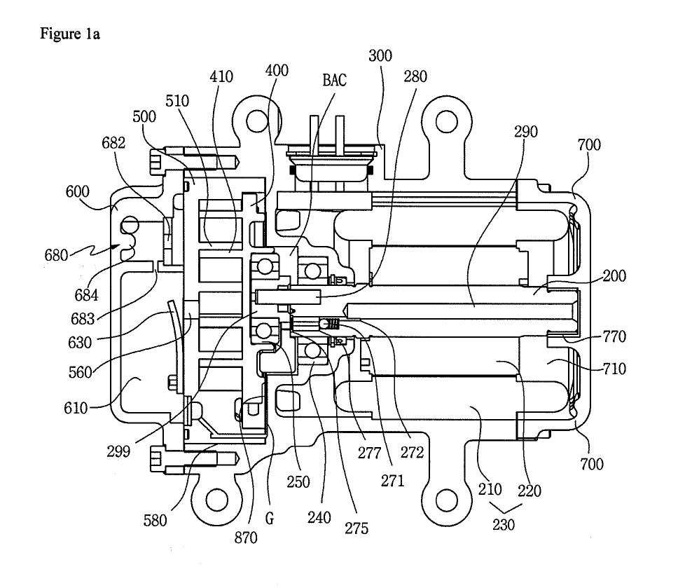

FIG. 1B is a perspective view illustrating an oil separating structure of FIG. 1A;

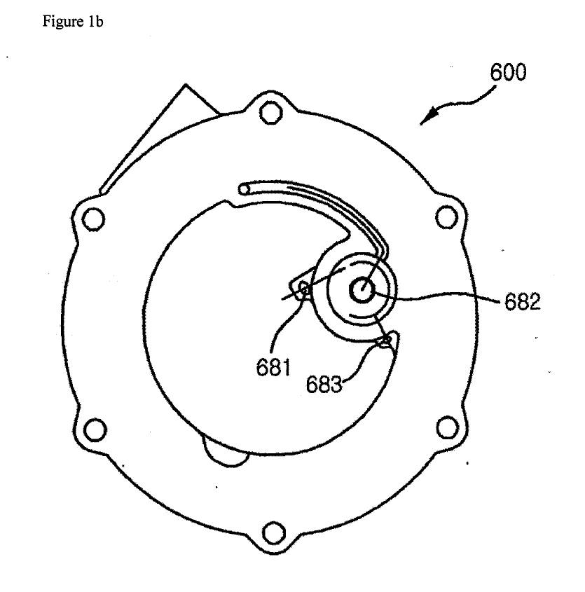

FIG. 1C is a longitudinal sectional view illustrating the oil separating structure of FIG. 1A;

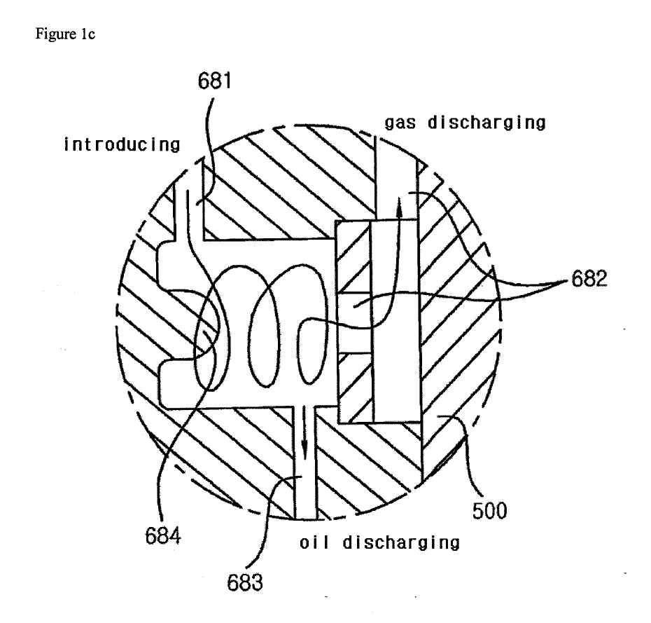

FIG. 2 is a longitudinal sectional view illustrating the structure of a scroll compressor including an oil separator according to the present invention;

FIG. 3 is a transverse sectional view illustrating an oil separator according to the present invention;

FIG. 4 is a longitudinal sectional view taken along a section A-A of FIG. 3 as an embodiment of the present invention; and

FIG. 5 is a longitudinal sectional view taken along a section A-A of FIG. 3 as another embodiment of the present invention.

### MODE FOR INVENTION

Hereinafter, exemplary embodiments of the present invention will be described in detail with reference to the accompanying drawings.

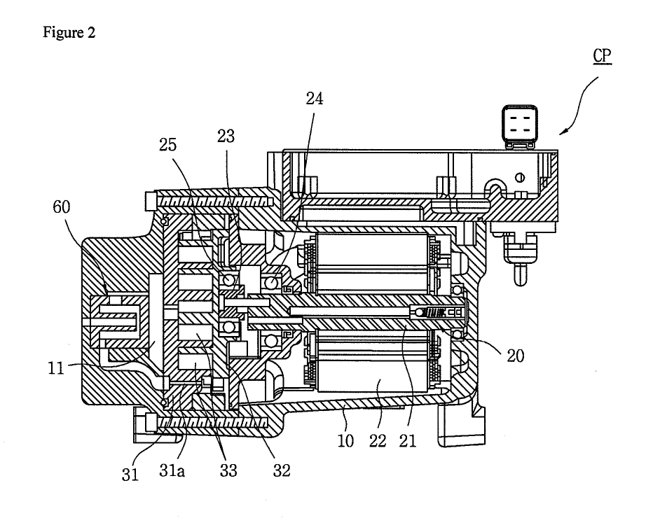

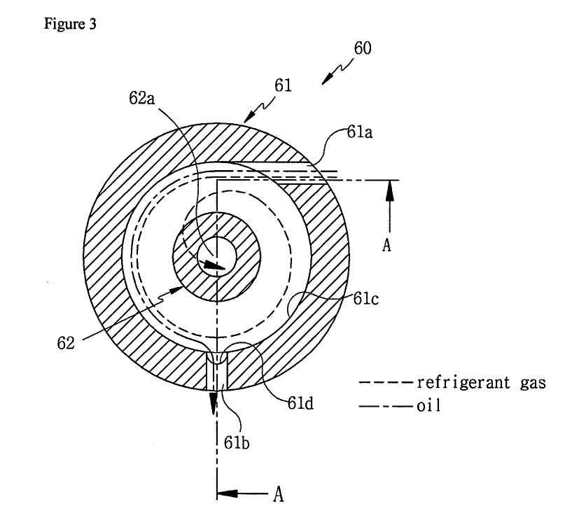

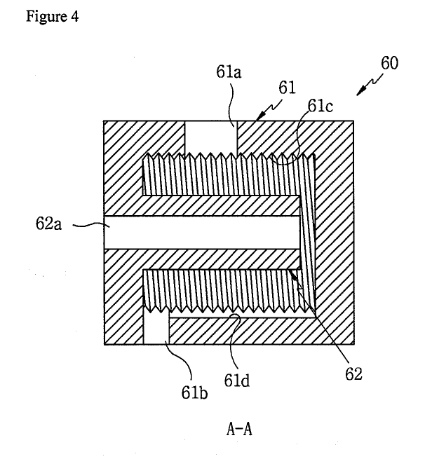

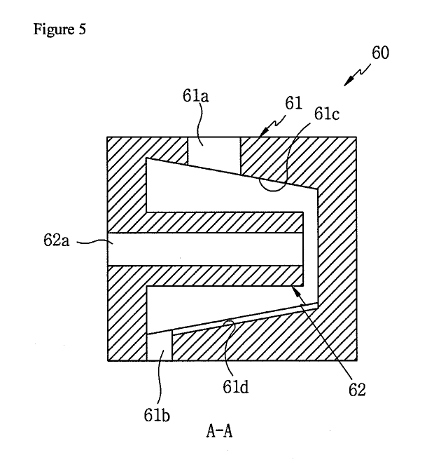

FIG. 2 is a longitudinal sectional view illustrating the structure of a scroll compressor including an oil separator according to the present invention. FIG. 3 is a transverse sectional view illustrating an oil separator according to the present invention. FIG. 4 is a longitudinal sectional view taken along a section A-A of FIG. 3 as an embodiment of the present invention. FIG. 5 is a longitudinal sectional view taken along a section A-A of FIG. 3 as another embodiment of the present invention.

Hereinafter, the embodiments of the present invention will be described in detail with reference to FIGS. 2 to 5.

As illustrated in FIG. 2, the scroll compressor CP according to the present invention includes a housing 10, a drive unit 20 installed within the housing 10 to generate a rotational force, a fixed scroll 31 and a orbiting scroll 32 disposed opposite to each other to form a compression chamber 33, and an oil separator 60 formed in a discharge chamber 11 of the housing 10.

The drive unit 20 generally includes a drive shaft 21, a drive motor 22, a sliding bush 23, a main bearing 24, and an auxiliary bearing 25.

The other structures of the scroll compressor CP may be variously employed, so a detailed description thereof will be omitted.

Here, the oil separator 60 functions to separate oil from a refrigerant which has passed through the compression chamber 33 such that only the gas refrigerant flows toward a condenser (not shown), preventing lowering of the efficiency of the compressor.

Besides, the oil separated by the oil separator 60 is supplied to a lower pressure portion (a vicinity of the outer periphery) of the compression chamber 33 or a bearing.

Hereinafter, the oil separator will be described in detail with reference to the accompanying drawings.

As illustrated in FIGS. 3 to 5, the oil separator 60 of the present invention includes a hollow outer body 61 having an inlet 61a and a drain hole 61b and an inner tube 62 having a discharge hole 62a at a center thereof.

Here, one end of the inner tube 62 is fixed to a wall surface of the outer body 61 at one side thereof, and an opposite end of the inner tube 62 is spaced apart from a wall surface of the outer body 61 on an opposite side thereof. That is, a passage is formed such that the refrigerant introduced through the inlet 61a by the outer body 61 and the inner tube 62 is communicated with the discharge hole 62a.

The inlet 61a may be inclined in a tangential direction of the inner peripheral surface 61c of the outer body 61. This structure maximally reduces a resistance resulted from a peripheral structure when the refrigerant passes through an initial portion of the inlet 61a and allows the refrigerant to smoothly proceed in the tangential direction of the inner peripheral surface 61c of the outer body 61 when the refrigerant enters the inlet 61a, generating a centrifugal force immediately.

Accordingly, a centrifugal force is applied to the refrigerant suctioned through the inlet 61a while the refrigerant is flowing along the inner peripheral surface 61c of the outer body 61, whereby the refrigerant is separated into gas and oil.

Thereafter, the separated oil is discharged through the drain hole 61b and then is guided by an orifice 31a (see FIG. 2).

Moreover, if an oil groove 61d for guiding the oil to the drain hole 61b is formed on the inner peripheral surface 61c of the outer body 61, the oil separated from the refrigerant gas can be smoothly guided to the drain hole 61b by the oil groove 61d.

Accordingly, the oil introduced into the oil groove 61d is not influenced by the centrifugal force of the refrigerant gas, being stably discharged to the drain hole 61b.

Meanwhile, as illustrated in FIG. 4, a spiral portion is formed on the inner peripheral surface 61c of the outer body 61 to widen a fusing area of the oil having a certain viscosity and is formed toward the drain hole 61b to guide the oil.

As illustrated in FIG. 5, a taper is formed on the inner peripheral surface 61c of the outer tube 61 such that the inner diameter of the outer tube 61 becomes larger as it goes toward the drain hole 61b such that the oil attached to the inner peripheral surface 61c of the outer body 61 can be guided toward the drain hole 61b in a natural manner.

Moreover, the above-described spiral portion and taper may be formed together on the inner peripheral surface 61c of the outer body 61, and a detailed description thereof will be omitted.

Thus, the refrigerant introduced into the inlet 61a is rotated on the inner peripheral surface 61c of the outer body 61 by a centrifugal force to be separated into refrigerant gas and oil, and the separated oil is discharged to the drain hole 61b by the taper and the oil groove 61d formed on the inner peripheral surface 61c of the outer body 61.

Thereafter, the refrigerant gas separated from the oil is guided to the discharge hole to be discharged toward the next step (condenser).

Meanwhile, while the oil separator 60 of the present invention is applied to a scroll compressor SC, the present invention is not limited thereto and may be applied to any apparatus for separation of gas and liquid.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

### INDUSTRIAL AVAILABILITY

According to the oil separator of the present invention, an oil separating effect can be maximized through enhancement of a centrifugal force.

Further, an oil separating performance can be maximized by preventing gas and oil from being remixed by guiding the flow direction of the oil separated by a centrifugal force using a spiral portion and a taper.

1. An oil separator comprising:
a hollow outer body having an inlet and a drain hole; and
an inner tube spaced apart from an inner peripheral surface of the outer body and having a discharge hole at a center thereof,
wherein the inner peripheral surface of the outer tube guides oil toward the drain hole opposite to the discharge hole.

2. The oil separator as claimed in claim 1, wherein a taper is formed on the inner peripheral surface of the outer tube such that the inner diameter of the outer tube becomes larger as it goes toward the drain hole.

3. The oil separator as claimed in claim 1, wherein a spiral portion is formed on the inner peripheral surface of the outer body.

4. The oil separator as claimed in claim 1, wherein the inlet is formed in a tangential direction of the inner peripheral surface of the outer body.

5. The oil separator as claimed in claim 4, wherein an oil groove is formed on the inner peripheral surface of the outer body along a lengthwise direction thereof.

6. The oil separator as claimed in claim 2, wherein a spiral portion is formed on the inner peripheral surface of the outer body.
